(19) United States
(12) Patent Application Publication
(10) Pub. No.: US 2025/0146989 A1
(43) Pub. Date: May 8, 2025

(54) SYSTEM AND METHOD FOR DETERMINING ORGANIC CHLORINE CONTENT IN PETROLEUM OR PETROCHEMICAL STREAMS

(71) Applicant: HPCL-Mittal Energy Limited, Punjab (IN)

(72) Inventors: Hemant Tyagi, Uttar Pradesh (IN); Anuj Gupta, Uttar Pradesh (IN); Anurag Pathak, Uttar Pradesh (IN); Manvendra Singh Patel, Uttar Pradesh (IN)

(21) Appl. No.: 19/020,364

(22) Filed: Jan. 14, 2025

(30) Foreign Application Priority Data
Nov. 27, 2024 (IN) 202411092849

(51) Int. Cl. G01N 31/16

(52) U.S. Cl. CPC G01N 31/164

(57) ABSTRACT

A system and method for determining organic chlorine content in petroleum or petrochemical streams are disclosed. The system comprises an injection module configured to introduce a sample, consisting of a 204° C. cut of washed naphtha or equivalent, into a gas stream; a gas supply unit configured to deliver a gas mixture of approximately 80% oxygen and 20% inert gas selected from argon, helium, or nitrogen, into the injection module; a combustion unit maintained at approximately 800° C. to convert chlorine in the sample to chloride and oxychlorides; a titration cell, comprising: an electrolyte containing 75% acetic acid in water, a silver ion solution to react with chloride ions in the sample, resulting in a measurable electrochemical reaction; and a microcoulometer configured to measure the electric current required to replace consumed silver ions in the titration cell, wherein the measured current is indicative of the organic chlorine content.

### CROSS-REFERENCE TO RELATED APPLICATION

This application claims the benefit of and priority to Indian Patent Application number 202411092849 filed Nov. 27, 2024, the contents of which being incorporated by reference in their entirety herein.

### TECHNICAL FIELD

The present disclosure relates to the field of analytical chemistry, more specifically to a system and method for determining organic chlorine content in petroleum or petrochemical streams, particularly at very low concentration levels.

### BACKGROUND

Chloride contamination in petroleum and petrochemical streams presents a substantial operational and economic challenge for the oil and gas industry. Crude oil, the primary feedstock for these industries, serves as a significant source of chloride impurities in both organic and inorganic forms. During the refining process, a desalting stage is typically used to remove inorganic chlorides, primarily through washing the crude oil with water and utilizing electrostatic separation techniques. However, this process is primarily effective for inorganic chlorides, leaving organic chlorides in the crude, which then persist and disperse across various fractions of petroleum and petrochemical products.

Organic chlorides present in these streams are particularly problematic, as they persist through multiple refining stages and lead to serious downstream issues. One critical issue is corrosion. Organic chlorides, when exposed to high temperatures and the presence of water, can decompose and form hydrochloric acid, a highly corrosive compound. This acid can severely damage pipelines, storage tanks, and processing equipment, increasing the risk of leaks, equipment failures, and safety hazards. Another significant challenge posed by organic chlorides is catalyst poisoning. In refinery units such as hydrocrackers and hydrotreaters, catalysts are essential for efficient processing; however, even trace levels of organic chlorides can poison these catalysts, reducing their effectiveness and resulting in lower product yields. This inefficiency not only affects product quality but also increases operational costs due to the need for more frequent catalyst regeneration or replacement.

Furthermore, the presence of organic chlorides can lead to product quality deterioration. In refined petroleum products, chlorides contribute to quality degradation by introducing unwanted impurities during processing. This degradation can affect the final product's compliance with regulatory standards and customer satisfaction. Additionally, organic chlorides contribute to operational challenges by forming deposits and causing fouling in equipment, which can hinder efficiency. Fouling requires frequent maintenance shutdowns for cleaning and repair, raising both operational costs and productivity losses.

Various methods are currently employed within refining operations to control and mitigate chloride content. Guard beds, for instance, are strategically placed within process streams to capture chlorides before they reach sensitive equipment. These guard beds are filled with adsorbents or absorbents designed to trap chlorides and prevent contamination. Catalytic dechlorination is another approach, using catalysts to convert organic chlorides into less harmful compounds, though this method requires careful control of operating conditions. Chemical treatment is also common, with chemicals added to the stream to react with chlorides and form non-corrosive compounds. Additionally, water washing is sometimes used to remove soluble chlorides by washing crude or intermediate streams with water, often in combination with other treatment methods. Monitoring and control practices, including regular testing of chloride levels, help refine treatment processes and maintain system efficiency, reducing the risk of unexpected equipment failures.

Accurate and reliable measurement of organic chloride content is essential for effective monitoring and control. However, existing test methods for organic chlorides have significant limitations. ASTM D4929 is a primary standard method for organic chloride determination in crude oil, with three distinct procedures, including sodium biphenyl reduction, oxidative combustion, and X-ray fluorescence spectrometry. Yet, ASTM D4929 is only applicable for chlorine concentrations above 1.0 mg/kg, making it insufficient for low-level detection needs. Another method, UOP 779, uses microcoulometry for chloride measurement within a range of 0.3 to 1000 mg/kg. However, it measures total chloride without distinguishing between organic and inorganic types, and some inorganic chlorides may be overlooked due to salt presence. ASTM D7359 and UOP 991 are Combustion Ion Chromatography (CIC)-based methods designed to measure trace levels of chlorine, fluorine, and sulfur, with detection limits as low as 0.10 mg/kg. Despite this sensitivity, they are specifically limited to aromatic hydrocarbons, rendering them unsuitable for a broader range of petrochemical and petroleum products.

Except for CIC techniques, no other methods are available to accurately analyze organic chlorides in petroleum or petrochemical streams at concentrations below 0.3 mg/kg. Moreover, CIC methods have a limited application scope, being primarily suitable for aromatic hydrocarbons. This restriction presents a critical gap in the ability to reliably detect low levels of organic chlorides in a diverse range of petrochemical and petroleum products.

In light of stricter regulatory requirements and the increasing need for superior product quality, there is a pressing demand for highly sensitive and accurate methods to detect low concentrations of organic chlorides in petroleum and petrochemical streams. A detection capability down to 0.1 mg/kg for organic chlorides would allow refineries and petrochemical plants to monitor contamination levels more effectively, helping to proactively mitigate corrosion, prevent equipment fouling, and protect catalyst performance. This would result in lower maintenance costs, increased operational efficiency, and enhanced product quality.

This disclosure addresses the limitations of existing organic chloride analysis methods by introducing a novel approach that utilizes microcoulometry to detect organic chlorine levels as low as 0.1 mg/kg in petroleum and petrochemical streams. By incorporating precise instrumentation and optimized conditions, this system provides a means to measure ultra-low concentrations of organic chlorides, ensuring safer operations, reduced equipment corrosion, improved catalyst protection, and better control over product quality in the oil and gas industry.

In view of the foregoing discussion, it is portrayed that there is a need to have a system and method for determining organic chlorine content in petroleum or petrochemical streams.

### BRIEF SUMMARY

The present disclosure seeks to provide a system and method for accurately measuring low levels of organic chlorine in various hydrocarbon products, including crude oil, intermediates, and refined products. This disclosure is particularly relevant to the petroleum refining, petrochemical, and oil and gas industries, where monitoring organic chlorine levels is crucial for process optimization, corrosion control, catalyst protection, and maintaining product quality. The disclosure leverages microcoulometry and other advanced analytical techniques to provide highly sensitive and reliable measurements of organic chlorine, addressing the limitations of existing test methods and enhancing the ability to detect ultra-low concentrations in diverse petroleum and petrochemical environments.

In an embodiment, a system for determining organic chlorine content in petroleum or petrochemical streams is disclosed. The system includes an injection module configured to introduce a sample, consisting of a 204° C. cut of washed naphtha or equivalent, into a gas stream. The system further includes a gas supply unit configured to deliver a gas mixture of approximately 80% oxygen and 20% inert gas selected from argon, helium, or nitrogen, into the injection module. The system further includes a combustion unit maintained at approximately 800° C. to convert chlorine in the sample to chloride and oxychlorides. The system further includes a titration cell, comprising: an electrolyte containing 75% acetic acid in water, and a silver ion solution to react with chloride ions in the sample, resulting in a measurable electrochemical reaction. The system further includes a microcoulometer configured to measure the electric current required to replace consumed silver ions in the titration cell, wherein the measured current is indicative of the organic chlorine content.

In one embodiment, the titration cell is prepared with fresh electrolyte after each test to maintain high accuracy for chlorine measurements down to a level of 0.1 mg/kg.

The system further comprises a dual-furnace configuration to optimize combustion efficiency, with each furnace set to approximately 1000° C. for complete conversion of organic chlorine to chloride, and a carrier gas flow control module maintaining the flow of inert gas at a rate of approximately 5±1 bar, ensuring a steady gas flow through the system.

Yet, in one embodiment, the microcoulometer is calibrated and optimized to achieve high sensitivity and precision by using an optimized sample injection volume of approximately 100 μL.

The system further comprises a preparation module for generating a stock solution of chlorine in isooctane, wherein reference materials with specified concentrations (1.0 mg/kg and 5.0 mg/kg) are diluted to achieve target concentrations for calibration.

In another embodiment, a method for determining organic chlorine content in petroleum or petrochemical streams is disclosed. The method includes injecting a prepared sample, selected from a 204° C. cut of washed naphtha or a crude oil sample, into a flowing gas stream comprising about 80% oxygen and 20% inert gas. The method further includes directing the gas and sample mixture through a combustion tube heated to approximately 800° C., converting organic chlorine in the sample to chloride and oxychlorides. The method further includes channeling the combustion products into a titration cell containing an electrolyte with 75% acetic acid in water and silver ions to facilitate titration. The method further includes measuring the electric current necessary to replace silver ions consumed in the titration reaction, thereby quantifying the organic chlorine content to a sensitivity level of 0.1 mg/kg.

The method further comprises preparing a new titration cell with fresh electrolyte for each analysis to ensure measurement precision and avoid carryover contamination.

Yet, in another embodiment, the gas flow through the combustion tube is regulated to 5±1 bar using inert gas as a carrier and oxygen as a combustion gas, optimizing the combustion and transfer of chloride ions, wherein the cell temperature is maintained at approximately 25° C. to enhance the stability of the electrolyte and silver ions during the titration process, improving sensitivity in chlorine quantification.

The method further comprises calibrating the microcoulometer using a stock solution of chlorine in isooctane, prepared by diluting reference materials with known chlorine concentrations, to accurately determine concentrations down to 0.1 mg/kg.

The method further comprises using acetic acid in the titration cell electrolyte to neutralize any residual alkaline substances, thereby enhancing the accuracy of subsequent oxidative combustion and titration steps.

An object of the present disclosure is to develop a system for accurately and efficiently determining organic chlorine content in petroleum or petrochemical streams.

Another object of the present disclosure is to enhance the sensitivity of the analysis to detect low levels of organic chlorine, particularly below 1.0 mg/kg.

Another object of the present disclosure is to improve the precision and accuracy of the measurement results.

Another object of the present disclosure is to simplify the analytical procedure and reduce analysis time.

Another object of the present disclosure is to minimize the use of hazardous chemicals and waste generation.

Another object of the present disclosure is to offer a cost-effective and environmentally friendly solution for organic chlorine analysis in petroleum and petrochemical industries.

Yet another object of the present disclosure is to deliver an expeditious and cost-effective method for accurately and efficiently determining organic chlorine content in petroleum or petrochemical streams.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a system for determining organic chlorine content in petroleum or petrochemical streams in accordance with an embodiment of the present disclosure;

FIG. 2 illustrates a flow chart of a method for determining organic chlorine content in petroleum or petrochemical streams in accordance with an embodiment of the present disclosure;

FIG. 3 illustrates a Table depicting test results of a repeat test conducted for the organic chloride test at the sub-ppm level in accordance with an embodiment of the present disclosure;

FIG. 4 illustrates a graph of the linearity of chloride analysis at a lower range in accordance with an embodiment of the present disclosure;

FIG. 5 illustrates a Table depicting the spiking of chloride in the HPG sample and test results of spike recovery in different samples in accordance with an embodiment of the present disclosure;

FIG. 6 illustrates a Table depicting an inter-laboratory comparison conducted for the analysis of chloride analysis as per test method UOP 991 (CIC technique) and test results of the sample in accordance with an embodiment of the present disclosure; and

FIG. 7 illustrates a Table depicting the analysis of a wide range of Petroleum and Petrochemical streams and test results in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail concerning the accompanying drawings.

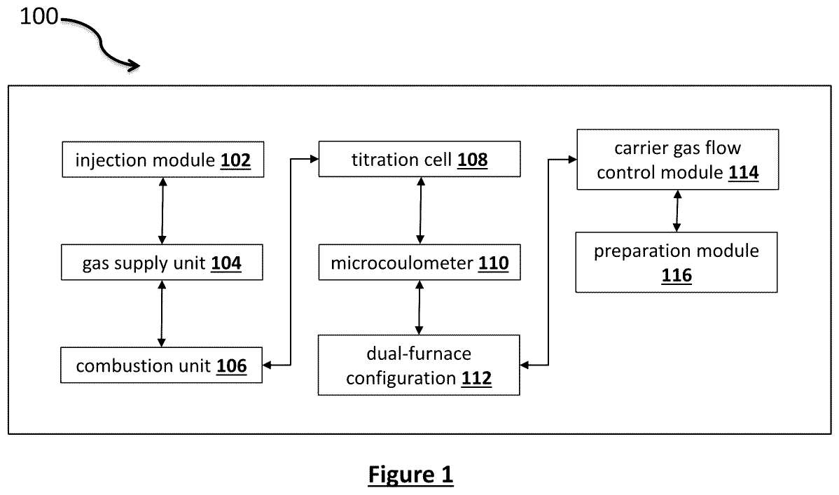

Referring to FIG. 1, a block diagram of a system for determining organic chlorine content in petroleum or petrochemical streams is illustrated in accordance with an embodiment of the present disclosure. The system 100 includes an injection module (102) configured to introduce a sample, consisting of a 204° C. cut of washed naphtha or equivalent, into a gas stream.

In an embodiment, a gas supply unit (104) is configured to deliver a gas mixture of approximately 80% oxygen and 20% inert gas selected from argon, helium, or nitrogen, into the injection module (102).

In an embodiment, a combustion unit (106) is maintained at approximately 800° C. to convert chlorine in the sample to chloride and oxychlorides.

In an embodiment, a titration cell (108), comprising an electrolyte containing 75% acetic acid in water, and a silver ion solution to react with chloride ions in the sample, resulting in a measurable electrochemical reaction.

In an embodiment, a microcoulometer (110) is configured to measure the electric current required to replace consumed silver ions in the titration cell, wherein the measured current is indicative of the organic chlorine content.

In one embodiment, the titration cell is prepared with fresh electrolyte after each test to maintain high accuracy for chlorine measurements down to a level of 0.1 mg/kg.

The system 100 further comprises a dual-furnace configuration (112) to optimize combustion efficiency, with each furnace set to approximately 1000° C. for complete conversion of organic chlorine to chloride, and a carrier gas flow control module (114) maintaining the flow of inert gas at a rate of approximately 5±1 bar, ensuring a steady gas flow through the system.

Yet, in one embodiment, the microcoulometer (110) is calibrated and optimized to achieve high sensitivity and precision by using an optimized sample injection volume of approximately 100 μL.

The system 100 further comprises a preparation module (116) for generating a stock solution of chlorine in isooctane, wherein reference materials with specified concentrations (1.0 mg/kg and 5.0 mg/kg) are diluted to achieve target concentrations for calibration.

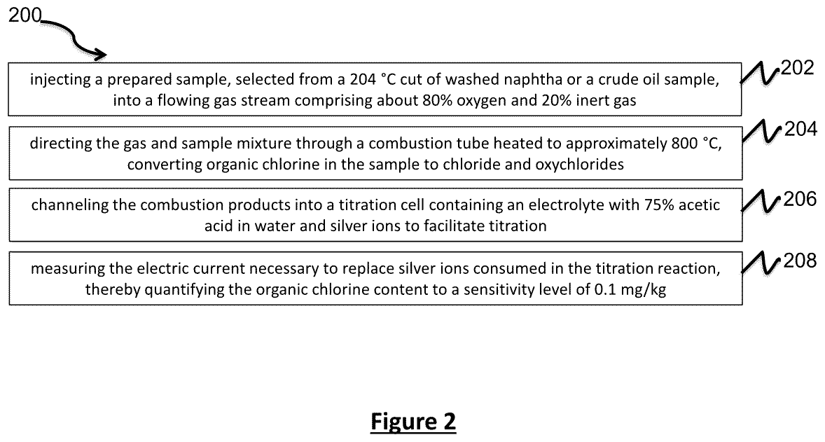

FIG. 2 illustrates a flow chart of a method for determining organic chlorine content in petroleum or petrochemical streams in accordance with an embodiment of the present disclosure. At step 202, method 200 includes injecting a prepared sample, selected from a 204° C. cut of washed naphtha or a crude oil sample, into a flowing gas stream comprising about 80% oxygen and 20% inert gas.

At step 204, method 200 includes directing the gas and sample mixture through a combustion tube heated to approximately 800° C., converting organic chlorine in the sample to chloride and oxychlorides.

At step 206, method 200 includes channeling the combustion products into a titration cell containing an electrolyte with 75% acetic acid in water and silver ions to facilitate titration.

At step 208, method 200 includes measuring the electric current necessary to replace silver ions consumed in the titration reaction, thereby quantifying the organic chlorine content to a sensitivity level of 0.1 mg/kg.

The method 200 further comprises preparing a new titration cell with fresh electrolyte for each analysis to ensure measurement precision and avoid carryover contamination.

Yet, in another embodiment, the gas flow through the combustion tube is regulated to 15±1 bar using inert gas as a carrier and oxygen as a combustion gas, optimizing the combustion and transfer of chloride ions, wherein the cell temperature is maintained at approximately 25° C. to enhance the stability of the electrolyte and silver ions during the titration process, improving sensitivity in chlorine quantification.

The method 200 further comprises calibrating the microcoulometer using a stock solution of chlorine in isooctane, prepared by diluting reference materials with known chlorine concentrations, to accurately determine concentrations down to 0.1 mg/kg.

The method 200 further comprises using acetic acid in the titration cell electrolyte to neutralize any residual alkaline substances, thereby enhancing the accuracy of subsequent oxidative combustion and titration steps.

In the present work, we have developed an innovative approach for the analysis of organic chlorine in Petroleum or Petrochemical streams up to a level of 0.1 mg/kg using micro coulometry technique (technique which is presently allowed to use for the analysis of organic chloride up to a level of only 1.0 mg/kg).

Specimen (204° C. cut of the washed naphtha fraction of a crude oil or sample as such, depending on boiling range) is injected into a flowing stream of gas containing about 80% oxygen and 20% inert gas, such as argon, helium, or nitrogen. The gas and sample flow through a combustion tube maintained at about 800° C. The chlorine is converted to chloride and oxychlorides, which then flow into a titration cell where they react with the silver ions in the titration cell. The silver ions thus consumed are coulometrically replaced. The total current required to replace the silver ions is a measure of the chlorine present in the injected samples. The reaction occurring in the titration cell as chloride enters is as follows:

Cl⁻+Ag⁺→AgCl(s)

The silver ion consumed in the above reaction is generated coulometrically thus:

Ag°→Ag⁺+e⁻

These microequivalents of silver are equal to the number of microequivalents of titratable sample ion entering the titration cell.

Equipment conditions of the testing equipment is kept in line with test method ASTMD4929 Procedure B with following optimization in titration cell to achieve the better accuracy at lower level:
1. The electrolyte contains 75% acetic acid in water.
2. Titration cell is to be prepared after completion of each test.

Usage of acetic acid helps in neutralizing any remaining alkaline substances (coming from the caustic wash of the streams) ensuring that the sample is properly prepared for the subsequent steps of oxidative combustion and microcoulometric titration used to determine the organic chloride content and resulting into better sensitivity.

### Experimental Work:

### Optimization of the Instrument for Analysis:

Instrument used: Tarce Elemental make instrument (model Xplorer)
Injection volume: 100 μl
Furnace-1 temperature: 1000° C.
Furnace-2 temperature: 1000° C.
Cell temperature: 25° C.
Carrier gas (Argon) flow: 5±1 bar
Combustion gas (Oxygen) flow: 5±1 bar
Cell preparation: It contains electrolyte having 75% acetic acid in water.

### Preparation of Stock Solution:

Solution Chlorine in isooctane (Product code CII05-UL-100; Lot no. 121423TN; ASI Standard) is used as Reference material for the preparation of stock solution for desired concentration. By the dilution of 1.0 mg/kg and 5.0 mg/kg reference material 0.1 mg/kg and 0.5 mg/kg Chlorine in isooctane solutions are prepared (using isooctane as solvent blank).

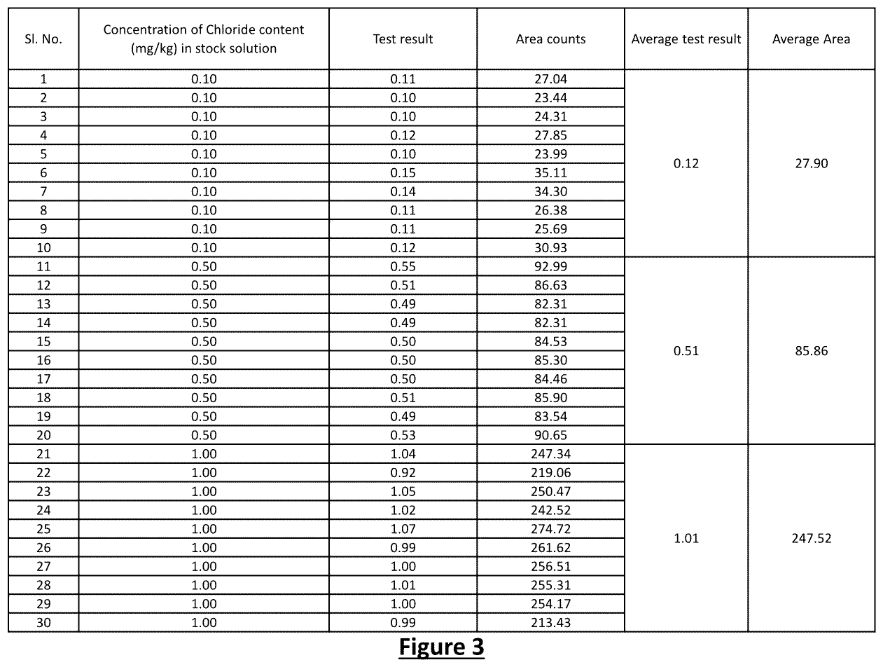

FIG. 3 illustrates a Table depicting test results of a repeat test conducted for the organic chloride test at the sub-ppm level in accordance with an embodiment of the present disclosure.

Repeatability, LOD and LOQ: Repeat test is conducted for the organic chloride test at sub ppm level and test results of repeat test is tabulated in FIG. 3.

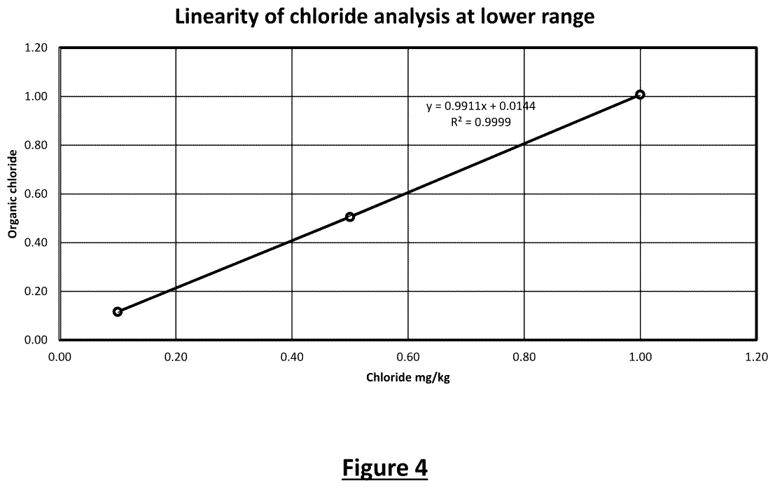

FIG. 4 illustrates a graph of the linearity of chloride analysis at a lower range in accordance with an embodiment of the present disclosure. By using the average test results of repeat test of 0.10, 0.50, and 1.00 mg/kg stock solutions of organic chloride, the regression coefficient is found to be 0.9999 and other statistical data like LOD and LOQ are illustrated in FIG. 4. The Standard Error (SE) was 0.00551, Slope (m) was 0.99111, Limit of Detection (LOD)=(3.3×SE/m) was 0.02, and Limit of Quantification (LOQ)=(10×SE/m) was 0.06 (˜0.1)

Method validation: Following protocols are used for the validation of newly developed test method:

### Recovery of Spiked Sample:

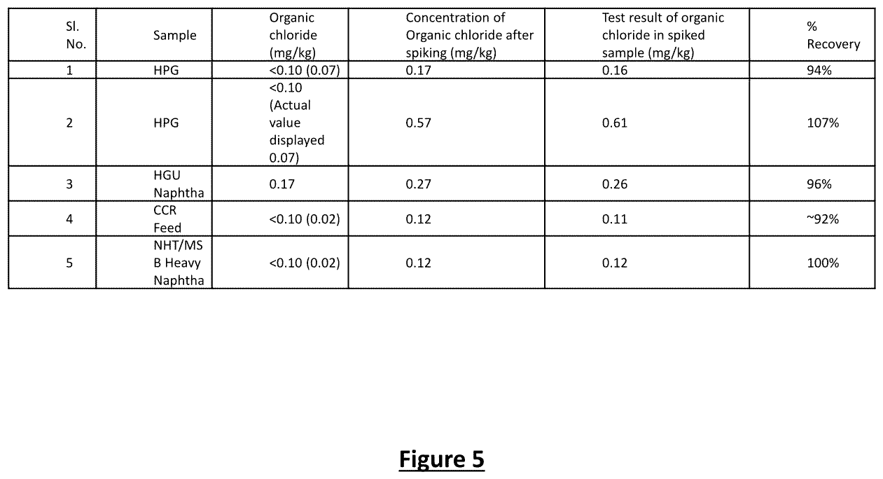

Spiking of chloride in HPG sample and test results of spike recovery in different samples is compiled in Table illustrated in FIG. 5.

FIG. 5 illustrates a Table depicting the spiking of chloride in the HPG sample and test results of spike recovery in different samples in accordance with an embodiment of the present disclosure.

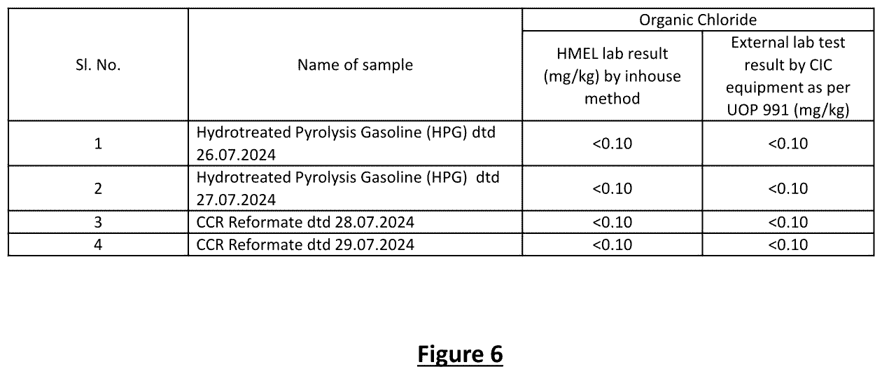

FIG. 6 illustrates a Table depicting an inter-laboration comparison conducted for the analysis of chloride analysis as per test method UOP 991 (CIC technique) and test results of the sample in accordance with an embodiment of the present disclosure.

Usage of alternative technology for inter laboratory comparison: Inter Laboratory comparison is conducted for the analysis of chloride analysis as per test method UOP 991 (CIC technique) and test results of the sample are depicted in Table in FIG. 6.

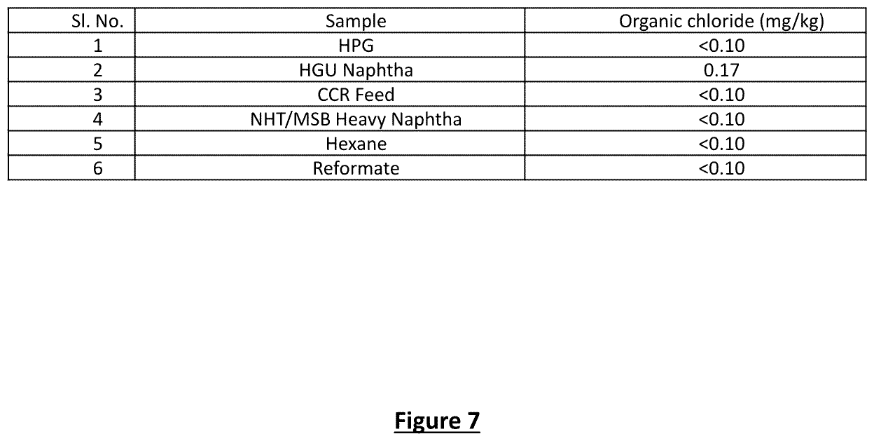

FIG. 7 illustrates a Table depicting the analysis of a wide range of Petroleum and Petrochemical streams and test results in accordance with an embodiment of the present disclosure.

Analysis of various Petroleum and Petrochemical stream: The newly developed method is used for the analysis of wide range of Petroleum and Petrochemical stream and test results are depicted in Table in FIG. 7.

The newly developed method is useful for the analysis of organic chloride in different Petroleum and Petrochemical products/streams having trace level of organic chloride without using CIC technique.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for determining organic chlorine content in petroleum or petrochemical streams, comprising:
an injection module configured to introduce a sample, consisting of a 204° C. cut of washed naphtha or equivalent, into a gas stream;
a gas supply unit configured to deliver a gas mixture of approximately 80% oxygen and 20% inert gas selected from argon, helium, or nitrogen, into the injection module;
a combustion unit maintained at approximately 800° C. to convert chlorine in the sample to chloride and oxychlorides;
a titration cell, comprising:
an electrolyte containing 75% acetic acid in water,
a silver ion solution to react with chloride ions in the sample, resulting in a measurable electrochemical reaction; and
a microcoulometer configured to measure the electric current required to replace consumed silver ions in the titration cell, wherein the measured current is indicative of the organic chlorine content.

2. The system of claim 1, wherein the titration cell is prepared with fresh electrolyte after each test to maintain high accuracy for chlorine measurements down to a level of 0.1 mg/kg.

3. The system of claim 1, further comprises:
a dual-furnace configuration to optimize combustion efficiency, with each furnace set to approximately 1000° C. for complete conversion of organic chlorine to chloride; and
a carrier gas flow control module maintaining the flow of inert gas at a rate of approximately 5±1 bar, ensuring a steady gas flow through the system.

4. The system of claim 1, wherein the microcoulometer is calibrated and optimized to achieve high sensitivity and precision by using an optimized sample injection volume of approximately 100 μL.

5. The system of claim 1, further comprises a preparation module for generating a stock solution of chlorine in isooctane, wherein reference materials with specified concentrations (1.0 mg/kg and 5.0 mg/kg) are diluted to achieve target concentrations for calibration.

6. A method for determining organic chlorine content in petroleum or petrochemical streams using the system of claim 1, comprising:
injecting a prepared sample, selected from a 204° C. cut of washed naphtha or a crude oil sample, into a flowing gas stream comprising about 80% oxygen and 20% inert gas;
directing the gas and sample mixture through a combustion tube heated to approximately 800° C., converting organic chlorine in the sample to chloride and oxychlorides;
channeling the combustion products into a titration cell containing an electrolyte with 75% acetic acid in water and silver ions to facilitate titration; and
measuring the electric current necessary to replace silver ions consumed in the titration reaction, thereby quantifying the organic chlorine content to a sensitivity level of 0.1 mg/kg.

7. The method of claim 6, further comprises preparing a new titration cell with fresh electrolyte for each analysis to ensure measurement precision and avoid carryover contamination.

8. The method of claim 6, wherein the gas flow through the combustion tube is regulated to 5±1 bar using inert gas as a carrier and oxygen as a combustion gas, optimizing the combustion and transfer of chloride ions, wherein the cell temperature is maintained at approximately 25° C. to enhance the stability of the electrolyte and silver ions during the titration process, improving sensitivity in chlorine quantification.

9. The method of claim 6, further comprises calibrating the microcoulometer using a stock solution of chlorine in isooctane, prepared by diluting reference materials with known chlorine concentrations, to accurately determine concentrations down to 0.1 mg/kg.

10. The method of claim 6, further comprises using acetic acid in the titration cell electrolyte to neutralize any residual alkaline substances, thereby enhancing the accuracy of subsequent oxidative combustion and titration steps.
